(19) United States
(12) Patent Application Publication
(10) Pub. No.: US 2008/0111260 A1
(43) Pub. Date: May 15, 2008

(54) LITHOGRAPHIC METHOD FOR FORMING MOLD INSERTS AND MOLDS

(76) Inventors: John Harchanko, New Market, AL (US); Rodney Clark, Gurley, AL (US); Takahisa Minamitani, Lacey's Spring, AL (US); Gregory J. Hofmann, Jacksonville Beach, FL (US); Thomas R. Rooney, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/740,555

(22) Filed: Apr. 26, 2007

Related U.S. Application Data
(62) Division of application No. 10/677,985, filed on Oct. 2, 2003, now abandoned.

(51) Int. Cl. B29D 11/00

(52) U.S. Cl. 264/1.36

(57) ABSTRACT

The present invention provides a lithographic method for manufacturing molds, and mold inserts, for use in producing ophthalmic lenses. The invention may be used in a method for the delivery of customized ophthalmic lenses to a lens wearer.

### FIELD OF THE INVENTION

The present invention relates to a method and apparatus for the manufacture of articles including, without limitation, ophthalmic lenses. In particular, the invention provides a method and device in which lithography is used to form mold inserts and molds useful in the manufacture of articles.

### BACKGROUND OF THE INVENTION

The use of ophthalmic lenses, including spectacle lenses, contact lenses, intraocular lenses, and the like for the correction of ametropia is well known. Production of the lenses using casting or molding requires the use of molds that impart the desired corrective characteristics onto the lens surfaces. Additionally, the manufacturing process may require the production of mold inserts as well. For example, in the manufacture of contact lenses metal inserts are fabricated and then used in the production of lens molds.

Typically, a large inventory of molds and molds inserts is required corresponding to each sphere, add, and cylinder power, and combinations thereof desired for the lens. Production and maintenance costs for the mold and mold insert inventory are high. Further, known processes for producing and using molds and mold inserts are not efficient and cost-effective methods for producing lenses customized to a particular wearer, such as a contact lens customized to a particular wearer's corneal topography.

One method for production of lenses that attempts to eliminate the need for large inventory molds is disclosed in U.S. Pat. No. 6,086,204. In this patent is disclosed the use of customized, heated dies, which utilize mechanical fingers, alone or in combination with a metal surface, to impart the desired corrective characteristics to a lens blank. This method is disadvantageous in that it is unsuitable for the production of certain ophthalmic lenses, such as soft contact lenses because soft contact lens materials are thermoset materials that cannot be deformed with heat. Additionally, this method is disadvantageous in that molding the lens material using a heated die requires that the lens blanks' optical axis be perfectly aligned with that of the die, which adds a great degree of difficulty to production of the lens. Finally, the disclosed method is not the most cost effective production method in that it is a thermal molding process. Therefore, a need exists for a method to produce lenses with a mold that permits reduction of lens inventory and which overcomes some or all of these disadvantages.

### BRIEF DESCRIPTION OF THE DRAWINGS

FIG. 1 illustrates the use of an illumination device and gray-scale mask to develop a photoresist or coating on a substrate blank.

FIG. 2A illustrates a flat-top blank.

FIG. 2B illustrates a flat-top blank onto which a photoresist or coating is deposited.

FIG. 3A illustrates a curved blank.

FIG. 3B illustrates a curved blank onto which a photoresist or coating is deposited.

FIG. 4A illustrates a curved blank with a developed photoresist or coating on its curved surface.

FIG. 4B illustrates the device of FIG. 4A with a desired curved surface remaining after the undeveloped photoresist or coating is removed.

FIG. 5A illustrates a curved blank with a developed photoresist or coating on its curved surface and from which the undeveloped photoresist or coating is removed.

FIG. 5B illustrates the device of FIG. 5A for which the developed photoresist or coating is etched to create a desired surface in the blank or substrate, with an optional coating.

### DESCRIPTION OF THE INVENTION AND ITS PREFERRED EMBODIMENTS

The present invention provides a lithographic method for manufacturing molds, and mold inserts, for use in producing articles including, without limitation, ophthalmic lenses. In the manufacture of lenses, the invention permits the production of a full prescriptive range of lenses while reducing the number of molds and mold inserts required. Further, the methods of the invention may be used in a method for the delivery of customized lenses.

The present invention is applicable to the molding and formation of various articles including, without limitation, lenses of various sizes. For purposes of illustration only, the examples herein may refer to ophthalmic lenses.

In one embodiment, the invention provides a curved surface for use in molding applications comprising, consisting essentially of, and consisting of a substrate, wherein said substrate is substantially transparent to a radiation source, said substrate having a coating with a curved surface, where the curved surface is used as the mold surface and is formed by a.) depositing a radiation-curable deposit on a first surface of the substrate and b.) the deposit is developed, selectively, by passing radiation through said substrate's second surface, opposite the first surface, the radiation entering into the deposit resulting in developed deposit and undeveloped deposit, and where the curved surface is the surface of the developed deposit away from the substrate surface.

In another embodiment, the invention provides a curved surface for use in molding applications comprising, consisting essentially of, and consisting of a substrate, wherein said substrate is substantially transparent to a radiation source, said substrate having a curved surface, where the curved surface is used as the mold surface and is formed by a.) depositing a radiation-curable deposit on a first surface of the substrate, b.) the deposit is developed, selectively, by passing the radiation through said substrate's second surface, opposite the first surface, the radiation entering into the deposit resulting in developed deposit and undeveloped deposit, the developed deposit forming a desired curved surface, and c.) the developed deposit is etched to form a mirror image, or replication, of the desired curved surface in the substrate resulting in the curved surface substrate.

In yet another embodiment, the invention provides a method comprising, consisting essentially of, and consisting of: a.) depositing a radiation-curable material onto at least one surface of a lens mold blank or lens mold insert blank; and b.) curing the radiation-curable material under conditions suitable to form an optical quality molding surface having optical characteristics on at least one surface of the radiation-curable material.

For purposes of the invention, the term “curing” and “developing” are used interchangeably. By “radiation-curable material” is meant a photoresist or coating that is curable by light, electron beam, gamma ray, heat, radio wave, microwave and the like.

For purposes of the examples in accordance with the invention, by “ophthalmic lens” is meant a spectacle lens, a contact lens, an intraocular lens, or the like. By “optical quality” is meant that the surface is sufficiently smooth so that a surface formed by the polymerization of a lens-forming material, or lens mold-forming material, in contact with the molding surface, is optically acceptable. Preferably, by “optical quality” is meant that the surface has a roughness of a RMS of less than about 100 nm, more preferably less than about 20 nm

By “lens mold blank” is meant a blank useful in forming a mold from which lenses may be molded. More specifically, in the process of the invention, radiation-curable material is deposited onto a surface of a lens mold blank and cured to form a surface on the blank which surface can be used to mold a lens surface. Similarly, by “lens mold insert blank” is meant a blank useful in forming a lens mold insert from which lens molds may be formed. By “optical characteristics” is meant one or more of spherical, aspheric, toric, or cylindric curvature, curvatures for the correction of aberrations of the third order or higher, and the like and combinations thereof.

Curved surfaces, for use in molds in accordance with the present invention, may be formed by using light or beam sources to develop, or cure, radiation-curable materials on blanks. In one embodiment of the method of the invention, a radiation-curable material is deposited on a substrate, herein also referred to as a blank, and cured by illuminating with light passing through a gray-scale mask and the blank. The uncured portions of the coating are removed and the remaining developed portions serve as the desired surface. In an alternative method, the developed material is etched resulting in an actual etching of the blank to form the desired surface. Both methods produce surfaces that can be covered with additional coatings.

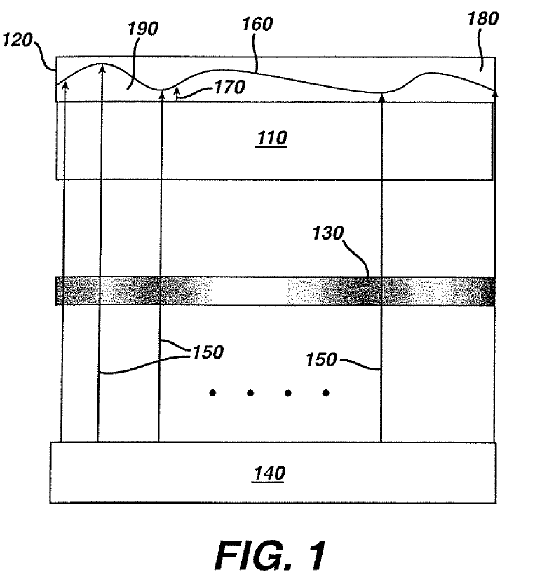

In FIG. 1 is generally depicted the method of developing a material in a blank. The blank 110 and radiation-curable material 120 are loaded onto a fixture that sets the position of the substrate relative to a gray-scale mask 130. This fixture preferably controls the position to at least about 10 microns and may be any suitable fixture including, without limitation, a precision x-y table. In the case in which a negative photoresist-like method is used, the material is exposed by passing illumination 150 which may, for example, be ultra-violet light, from an illumination source 140 through the gray-scale mask 130 and then through the blank 110. The illumination passes through the blank 110 and into the material 120 developing the material 190 depending upon the penetration depth 170 determined by gray-scale mask 130. Typically, the UV light intensity onto the gray-scale mask is about 1 mW to about 5 W and the exposure time is about 0.5 to about 30 seconds. Developing, or curing time, will depend upon the radiation-curable material used as well as the intensity of the radiation.

Curing produces a developed, radiation-curable material 190 with a surface 160 having the desired configuration. Following exposure, uncured material 180 is removed. Removal may be carried out by any convenient means including, without limitation, by spinning off the uncured material. Use of a solvent such as acetone, ethanol, tetra-methyl ammonium hydroxide, methylene chloride or the like is possible, but not preferred.

In a preferred method, spinning off of the uncured material is carried out under a nitrogen atmosphere and three cycles are used: one at about 200 to about 400 rpm for 30 seconds; one at 700 rpm for about 30 seconds; and a third cycle at about 2000 rpm for about 120 seconds During the final rotation, the surface 55 is cured as, for example, by exposure to 16 mW/cm² of light at 365 nm shuttering on and off at about 0.5 cycles/second. Even after removal of the uncured material, a thin layer will remain. During the third cycle of the spin process, the thin layer remaining is curing while the mold remains in motion thus polymerizing the layer while the dynamic forces are in effect.

As stated above, the first step of the method of the invention, radiation-curable material is deposited onto a lens mold, or lens mold insert, blank. Preferably, the blank is transparent to light in the range of about 150 to about 500 nm. Methods for forming blanks are well known in the industry. For example, polymeric blanks may be formed by molding, casting, or the like while metal blanks may be formed using diamond-point turning and glass blanks may be formed by grinding or polishing. The blanks may be formed of any material normally used in the semi-conductor or ophthalmic industry. Suitable materials include, without limitation, polystyrene, polymethylmethacrylates, polycarbonates, polyoxymethylene, propylene, polyetherimides, nylons, polyvinylchlorides, cyclic olefins, brass, nickel-coated brass, stainless steel, nickel-coated stainless steel, aluminum, and the like.

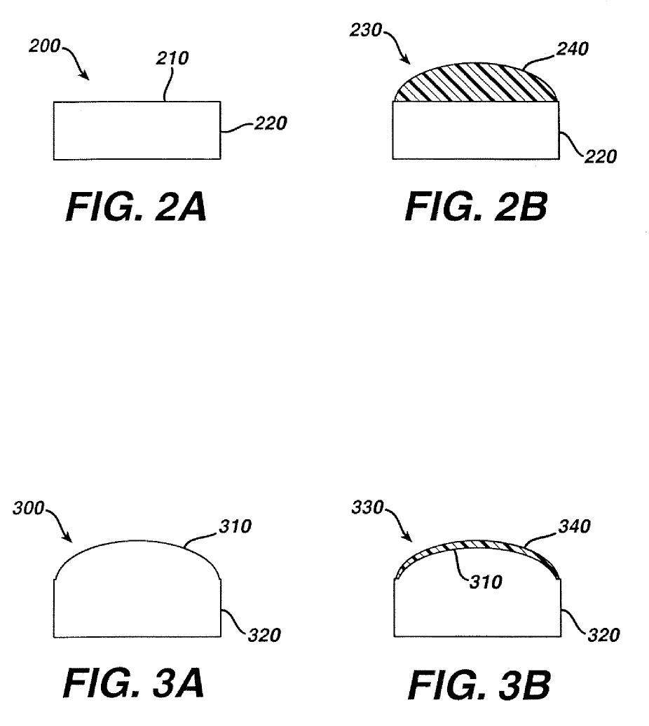

In FIGS. 2 and 3 are depicted two types of blanks useful in the method of the invention. In FIG. 2A is depicted flat-topped blank 200 having flat surface 210 and base 220. In FIG. 2B is depicted a flat-topped blank with a deposit 230. Radiation-curable material 240 is deposited on the flat surface 210. In FIG. 3A is depicted curved blank 300 with a curved surface 310 onto which, as shown in FIG. 3B, radiation-curable material 340 is deposited. The deposits 240 and 340 are developed by radiation into desirable shapes by use of a radiation, or illumination, source.

Radiation-curable material useful in the invention preferably is compatible with the material from which the lens, or lens mold, is to be formed. Factors for determining whether the radiation-curable material is compatible include, without limitation, whether it adheres to or chemically reacts with the lens-forming or lens mold forming material. Additionally, if the lens or lens mold to be formed from the mold or mold insert will be cured using ultra-violet or visible light cure, the radiation-curable material preferably is transmissive of light of the appropriate wavelength. In embodiments in which a lens mold insert is being formed from the radiation-curable material and mold insert blank, the cured radiation-curable material preferably has a Shore D hardness of at least about 70. Further, in embodiments in which the material is being deposited onto a lens mold blank, the cured or uncured radiation-curable material must be one suitable for depositing in a layer of between about 10 and 500 microns. Other desirable properties of the radiation-curable material will depend upon whether it is being used in the formation of a lens mold or a lens mold blank. In general, however, the uncured, or undeveloped, radiation-curable material preferably has a viscosity of less than about 500 cps at 25° C., a cure shrink of <20%, a cured tensile strength of greater than about 750 psi, and a cured water absorption of less than about 1% by volume. Suitable commercially available materials include, without limitation, urethane acrylates, cycloaliphatic epoxies, polyurethane oligomers, hydrogenated bis-phenol A epoxies, poly(norbornene) epoxies and the like and combinations thereof

The radiation-curable material may be deposited by any convenient method that ensures that the entire blank surface is covered and that there are no voids at the interface between the blank and the material. Suitable methods of deposition depend upon whether a positive or a negative photoresist-like method is used. A “negative photoresist-like method” means that an excess of material is deposited, a portion of it is cured, and the uncured material is removed. By “positive photoresist-like method” means that the amount necessary to form the desired surface is deposited and cured. If a negative photoresist-like method is used, the material may be deposited without thickness control so long as a substantiality continuous contact results between the substrate and the material. In the case in which a negative photoresist-like method is used to produce a contact lens mold or mold insert, typically about 50 mg to about 1 g of material will be deposited. If a positive photoresist-like method is used, the radiation-curable material is dispensed onto the surface in a manner so that the thickness is controlled within desired parameters. In this case, deposition is typically carried out using a spin coater.

In the development step b.), the radiation-curable material is cured by any suitable method including, heat, light, or other radiation cure, and combinations thereof. Preferably, light at about 100 to about 800 nm from a fusion lamp, metal halide lamp, arc lamp, or the like is used. Curing may take place under any suitable conditions of temperature, pressure and time. Preferably, a cure using light in the range of about 150 to about 500 nm at room temperature and atmospheric pressure are used and curing is carried out under a nitrogen blanket for about 0.1 seconds to about 30 minutes. The specific time for completion of curing will depend upon the material selected and the thickness of the material and whether heat, light, or other radiation is used.

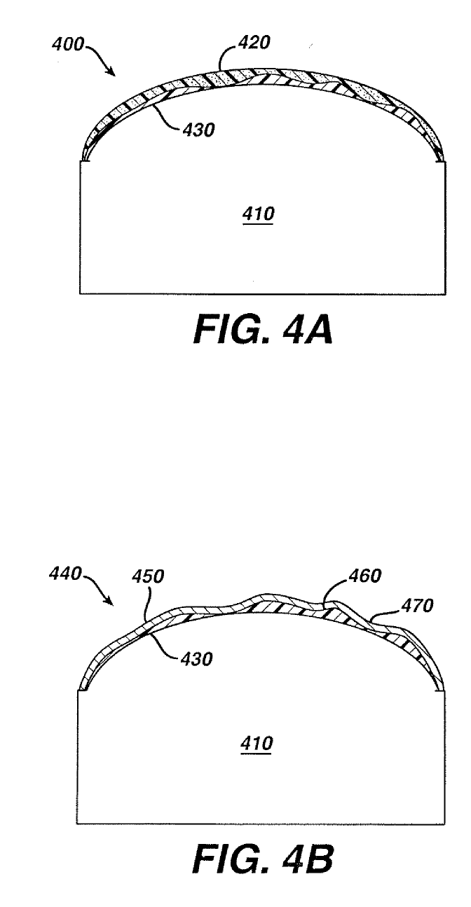

In FIG. 4 is depicted a step 400 in which a curved blank's 410 curved surface is coated with a developed radiation-curable material 430 and an undeveloped coating 420. The development of the coating is carried out in accordance with the methods described with respect to FIG. 1. In FIG. 4B is depicted the step 440 in which the uncured coating 420 is removed and an optional coating 450 placed upon the remaining developed coating 430. The radiation-curable material was deposited onto curved surface of the blank 410, which blank is transparent to the curing radiation. For example, blank or mold blank, 410 may be transparent to UV light, which is transparent to UV light. Light from a UV light source is then passed through gray-scale mask to cure the material. The gray-scale mask is used to control the intensity of UV light impinging on the material. The desired surface profile is used as a datum, or reference surface, from which the transmission depth of the UV light into the radiation-curable material is set. By setting the transmission depth, desired optical characteristics may be imparted to surface of material. As an alternative to the gray-scale mask, an electronic gray scale mask may be used, for example an array of liquid crystal display (“LCD”) cells or comparable spatial light modulators.

In more detail, curing using a gray-scale mask is carried out as follows. In using a gray-scale mask, the object is to modulate the intensity of light that impinges onto the radiation-curable material at each point on the surface to be formed. The degree to which the light intensity is modulated will be determined by the penetration depth required for each point on the surface.

Material calibration is carried out to provide the curve relating the depth to which the material will be cured to a gray-scale level, or to the incident intensity of the curing radiation on the radiation-curable material. In carrying out the material calibration, the photoresist is exposed and the uncured photoresist is removed. The shape of the resultant surface is measured by any convenient means, as for example by use of a VEECO™ white light interferometer, to determine the penetration depth at each point on the cured photoresist. Since each point will correspond to a point on the gray-scale mask, this yields a calibration curve. Repeating the procedure yields a curve with estimates of the penetration depth variances.

One ordinarily skilled in the art will recognize that use of a gray-scale mask is only one way in which to modulate the light intensity, Alternatively, modulation may be carried out using a adaptive mirror to generate a wavefront the intensity of which is modulated across its surface, using a bundle of fiber optics to generate a spatially modulated intensity of light, and using a discrete array of mirrors to deflect the light.

A gray-scale mask may be made by any convenient method. For example, and without limitation, the gray scale mask may be formed by printing differing levels of gray shades onto a transparency using a printer with a resolution of about 600 or greater. Alternatively, an electronic gray scale mask may be formed using an array of liquid crystal displays in which the light transmission of each LCD cell can be controlled by supplying a voltage to the cell. As yet another alternative, a mask may be produced by use of direct electron beam writing according to well-known methods. Performance of printed gray scale masks may be optimized by vibrating the mask at a small amplitude and in a random direction. Alternatively, the lens residing between the mask and the substrate may be defocused Either of these techniques acts to provide the discrete nature of the dots from which the printed mask is formed from transferring to the developing material.

The gray-scale level, or radiation intensity, is based on the lens mold or lens mold insert, design, the substrate design, and the calibration curve. The mold or mold insert design determines the thickness of the material at each location on the substrate and this dictates the depth to which curing radiation is needed to penetrate the material at each location. The gray-scale level is then determined by conversion of the penetration depth information into gray-scale level information using the calibration curve.

In FIG. 4B is shown blank 410 after uncured or undeveloped material 420 is removed to expose surface 460 defined by developed material 430. The cured material 430, with optional coating 450, then may be used as a back curve mold half in production of a lens, surfaces 460 and 470 being used to form a surface of the lens. In such a case, surfaces 460 and 470 must be of optical quality. The size, shape, and thickness of cured material 430 will be dependent on the type of lens to be produced. Preferably, it is about 0.5 to about 5000 microns in thickness.

As an optional step, the cured radiation-curable material may be coated 450. The material may be coated with any coating suitable to form a highly crosslinked, non-chemically reactive surface suitable for release of the lens by using standard methods and practices. The coating may be applied by any suitable method. Preferably, the resultant coating layer is about 5 to about 10 microns in thickness.

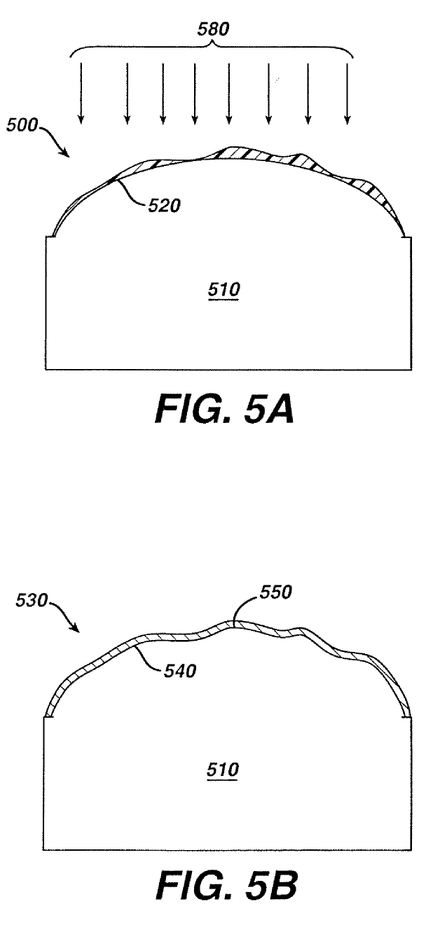

In another embodiment, displayed in FIGS. 5A and 5B, the surface of the blank 510 is etched and serves as the mold surface. FIG. 5A depicts the step 500 in which a curved blank 510 is left with a developed coating 520. The developed coating 520 is etched 580. For example, the developed coating 520 may be plasma, for example HF ion, or wet etched or can be laser etched as is commonly used in semi-conductor etching. The etching method is for example purposes only and the discussion herein is not to be interpreted to limit the etching techniques.

FIG. 5B shows the etched mold 530 formed from the etched surface 540 of the substrate 510. The etched surface 540 will have the same optical qualities described above with respect to the developed coating surfaces 460 as discussed above.

The mold shown in FIGS. 4B and 5B are back mold halves suitable for molding the back surface, or eye side surface, of a lens. For purposes of molding a lens, a complementary mold half is used. The molds of the invention may be composed of two mold halves, each of which is formed from radiation-curable material. Alternatively, one mold half may be formed from the material and the other mold half by conventional means using conventional material. The mold halves may be brought into contact for purposes of molding the lens using any suitable contacting means including, without limitation, stepper motors, screw drives, or the like, and combinations thereof When positioned for molding of the lens, the mold halves may contact one another. In this case, preferably a sealing means is used to seal the molds so that an acceptable lens edge is formed. For example, the mold halves may be contacted so that an interference fit is formed between the halves. In this method, the back mold half is forced into the front mold half so that a seal forms. Additional suitable sealing means include, without limitation, a mechanical inter-lock, a gasket, o-ring, and the like, and combinations thereof. If the mold halves do not contact each other, preferably a mask is used to expose only those areas at which polymerization is desired. The mold halves and molds of the invention may be supported by any suitable support means. Supporting means include, without limitation, a pallet, a support frame, or the like, and combinations thereof.

In a preferred method of forming lenses, a lens-forming material may be deposited on the molding surface by any suitable means. The volume of lens-forming material dispensed into the cavity will be a lens forming amount which is an amount effective to form the desired ophthalmic lens. Typically, the amount of material deposited will be about 0.01 mg to about 1000 g.

Suitable lens-forming materials for lenses such as contact lenses are any materials useful for forming hard or soft contact lenses. For example, , the lens-forming material may be suitable for forming a soft contact lens. Illustrative materials for formation of soft contact lenses include, without limitation silicone elastomers, silicone-containing macromers including, without limitation, those disclosed in U.S. Pat. Nos. 5,371,147, 5,314,960, and 5,057,578 incorporated in their entireties herein by reference, hydrogels, silicone-containing hydrogels, and the like and combinations thereof More preferably, the surface is a siloxane, or contains a siloxane functionality, including, without limitation, polydimethyl siloxane macromers, methacryloxypropyl polyalkyl siloxanes, and mixtures thereof, silicone hydrogel or a hydrogel, such as etafilcon A.

A preferred lens-forming material is a poly 2-hydroxyethyl methacrylate polymers, meaning, having a peak molecular weight between about 25,000 and about 80,000 and a polydispersity of less than about 1.5 to less than about 3.5 respectively and covalently bonded thereon, at least one cross-linkable functional group. This material is described in Attorney Docket Number VTN 588, U.S. Ser. No. 60/363,630 incorporated herein in its entirety by reference.

As yet another alternative, the lens-forming material may be any material suitable for forming ophthalmic lens other than contact lenses. For example, spectacle lens-forming materials may be used including, without limitation, polycarbonates, such as bisphenol A polycarbonates, allyl diglycol carbonates, such as diethylene glycol bisallyl carbonate (CR-39™), allylic esters, such as triallyl cyanurate, triallyl phosphate and triallyl citrate, acrylic esters, acrylates, methacrylates, such as methyl- ethyl- and butyl methacrylates and acrylates, styrenics, polyesters, and the like and combinations thereof.

Suitable materials for forming intraocular lenses include, without limitation, polymethyl methacrylate, hydroxyethyl methacrylate, inert clear plastics, silicone-based polymers, and the like and combinations thereof.

Curing of the lens forming material deposited within the mold may be carried out by any means known including, without limitation, thermal, irradiation, chemical, electromagnetic radiation curing and the like and combinations thereof. Preferably, molding is carried out using ultraviolet light or using the full spectrum of visible light. More specifically, the precise conditions suitable for curing the lens-forming material will depend on the material selected and the lens to be formed.

Polymerization processes for contact lenses are well known. Suitable processes are disclosed in U.S. Pat. No. 5,540,410 incorporated herein in its entirety by reference, For formation of contact lenses, a preferred curing condition is to pre-cure the mold assembly using UV light with an intensity of about 2 to about 10 mW/cm². Following the pre-cure, the mold assembly is exposed to UV light of an intensity of about 0 to about 10 mW/cm² Suitable wavelengths are about 300 to about 500 nm. The time for the low intensity exposure will depend on the lens-material selected, the type and amount of any initiator used, material viscosity and the nature of its reactive groups, and the intensity of the UV light. Both pre-cure and subsequent UV exposure may, and preferably are, carried out as single, continuous exposures. However, the exposures also may be carried out using alternating periods of UV exposure and non-exposure periods. The polymerization steps preferably is carried out at a temperature between about 40 to about 75° C. and atmospheric pressure preferably under a blanket of nitrogen gas. Total cure time is between about 300 to about 500 seconds.

In an embodiment in which the poly 2-hydroxyethyl methacrylate polymers having a peak molecular weight between about 25,000 and about 80,000 and a polydispersity of less than about 1.5 to less than about 3.5 are used, preferably UV (about 315—about 400 nm), UVB (about 280—about 315) or visible light (about 400—about 450 nm), at an intensity of about 100 mW/cm² to about 50,000 mW/cm² is used. The cure time will be generally less than about 30 seconds and preferably less than about 10 seconds at about ambient temperature. Regardless of the polymerization method selected, the precise conditions will depend upon the components of lens material selected and are within the skill of one of ordinary skill in the art to determine.

The invention will be clarified further by a consideration of the following, non-limiting example.

### EXAMPLE

Two concave glass mold half blanks were coated with approximately 1 ml of Norland Optical #72 epoxy, which was dispensed into each of the mold halves. Curing was carried out for one of the mold half blanks for 5 seconds using radiation at 20 mW/cm² and the other for 20 seconds at 80 mW/cm² of UV light (356 nm), both at room temperature. Excess epoxy was removed by spinning the mold halves according to the spin profile set forth in Table 1. During the final spin cycle, the outer surface of the epoxy layer was cured by exposure to 10 to 20 mW/cm² of UV light (356 nm) at room temperature.

TABLE 1

| | Spin Rate | Dwell Time |
|---|---|---|
| First Cycle | 400 rpm | 30 seconds |
| Second Cycle | 700 rpm | 30 seconds |
| Third Cycle | 2000 rpm | 120 seconds |

### The resulting cured epoxy surfaces of the first and second mold halves had a RMS of 28 nm and 26 nm, respectively.

Many variations in the design and method of creating molds for the manufacture of lenses may be realized in accordance with the present invention. It will be obvious to one of ordinary skill in the art to vary the invention thus described. Such variations are not to be regarded as departures from the spirit and scope of the invention and all such modifications as would be obvious to one skilled in the art are intended to be included within the scope of the following claims.

1. (canceled)

2. (canceled)

3. A method comprising the steps of: a.) depositing a radiation-curable material onto at least one surface of a lens mold blank or lens mold insert blank; and b.) curing the radiation-curable material under conditions suitable to form an optical quality molding surface having optical characteristics on at least one surface of the radiation-curable material.

4. The method of claim 3, wherein curing further comprises modulating radiation.

5. The method of claim 4, wherein the modulating is carried out by using a mask, using an adaptive mirror, using spatial modulation, or using a discrete array of mirrors.

6. The method of claim 4, wherein the modulation is carried out using a gray-scale mask.

7. The method of claim 3, wherein the radiation-curable material is a urethane acrylate, a cycloaliphatic epoxy, a polyurethane oligomer, a hydrogenated bis-phenol A epoxy, a poly(norbornene) epoxy, or a combination thereof.

8. The method of claim 4, wherein the radiation-curable material is a urethane acrylate, a cycloaliphatic epoxy, a polyurethane oligomer, a hydrogenated bis-phenol A epoxy, a poly(norbornene) epoxy, or a combination thereof.

9. The method of claim 6, wherein the radiation-curable material is a urethane acrylate, a cycloaliphatic epoxy, a polyurethane oligomer, a hydrogenated bis-phenol A epoxy, a poly(norbornene) epoxy, or a combination thereof.

10. The method of claim 4, wherein curing is carried out using light at about 100 to about 800 nm.

11. The method of claim 6, wherein curing is carried out using light at about 100 to about 800 nm.

12. A method comprising the steps of: a.) depositing a radiation-curable material onto at least one surface of a lens mold blank or lens mold insert blank; b.) curing the radiation-curable material under conditions suitable to form an optical quality molding surface having optical characteristics on at least one surface of the radiation-curable material; and c.) coating the optical quality surface.
